(19) United States
(12) Patent Application Publication
(10) Pub. No.: US 2013/0288540 A1
(43) Pub. Date: Oct. 31, 2013

(54) IMPEDANCE MATCHED CONTACT MODULE

(71) Applicant: HON HAI PRECISION INDUSTRY CO., LTD., New Taipei (TW)

(72) Inventor: MU CHENG, Kunshan (CN)

(73) Assignee: HON HAI PRECISION INDUSTRY CO., LTD., New Taipei (TW)

(21) Appl. No.: 13/872,316

(22) Filed: Apr. 29, 2013

(30) Foreign Application Priority Data
Apr. 28, 2012 (CN) 201210129549.1

(51) Int. Cl. H01R 24/76

(52) U.S. Cl. CPC H01R 24/76
USPC 439/688

(57) ABSTRACT

A contact module includes a number of conductive contacts separating from one another, the contacts being formed from a contact material band by cutting a connecting portion connected between two adjacent contacts, wherein each contact has a tuber or a notch formed by cutting the connecting portion, and wherein each contact has a compensating portion corresponding to the tuber or the notch for impedance matching.

### BACKGROUND OF THE INVENTION

1. Field of the Invention

The present invention relates to a contact module and particularly to such contact module that accounts for impedance matching.

2. Description of Prior Arts

U.S. Pat. No. 7,572,156 discloses a CXP electrical connector. In an exemplary lead frme and a contact module formed using the lead frame, a number of terminals are joined together by a material band and adjacent terminals are connected with each other by connection portions. A pair of opposite cutting cutouts are defined in two sides of the connection portion for facilitating separation of the terminals from the material band by means of a cutter. After the connection portions are cut off, the cut portions in the terminal project out the cutting cutouts.

U.S. Patent Application Publication No. 2013/0012038 discloses an SFP electrical connector, wherein a terminal thereof includes an intermediate portion having a retention segment. The retention segment is generally the same width as in other portions of the intermediate portion of the terminal.

It is desired to be able to provide a simple structure for compensating the impedance of the contact.

### SUMMARY OF THE INVENTION

An object of the present invention is to provide a contact module, wherein when the connecting portions between the contacts in a lead frame are cut, the impedance of the contact is not adversely affected.

To achieve the above object, the present invention provides a contact module comprising a number of conductive contacts separating from each other, the contacts formed from a contact material band, the contact material band having a connecting portion connected two adjacent contacts, the connecting portion being cut from the contact material band for separating the adjacent contacts; wherein each contact has a tuber or a notch formed from the cutting process; wherein each contact has a compensating portion disposed before the cutting process and corresponding to the tuber or the notch for impedance mating.

Compared with the prior arts, the present invention provides a compensating portion to make the impedance of the contact matching better.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector;

FIG. 2 is another perspective view of the electrical connector as shown in FIG. 1;

FIG. 3 is an exploded view of a contact module wherein, prior to separating adjacent contacts, compensation portions are formed;

FIG. 4 is an exploded view of the contact module where adjacent contacts have been separated and tubers are formed from the cutting portions;

FIG. 5 is an exploded view of a contact module where adjacent contacts have not been separated and compensation portions are provided;

FIG. 6 is an exploded view of the contact module where adjacent contacts have been separated and notches are formed from the cutting portions.

### DETAILED DESCRIPTION OF THE PREFERRED EMBODIMENT

Reference will now be made to the drawing figures to describe the present invention in detail.

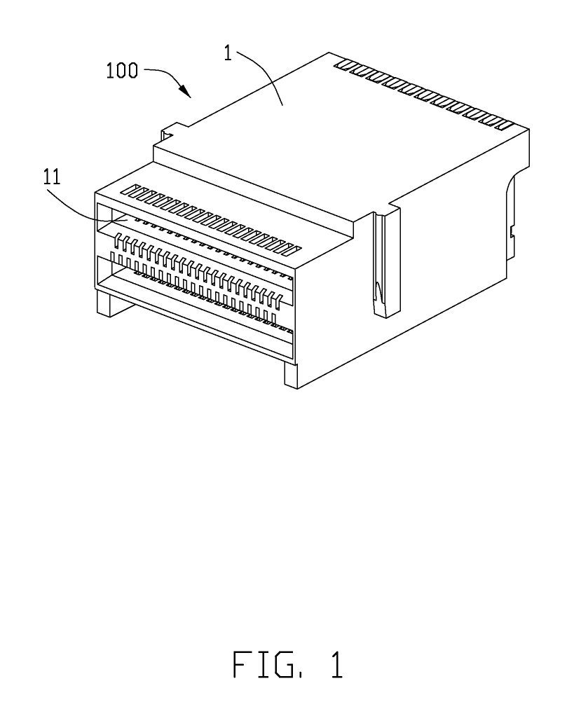

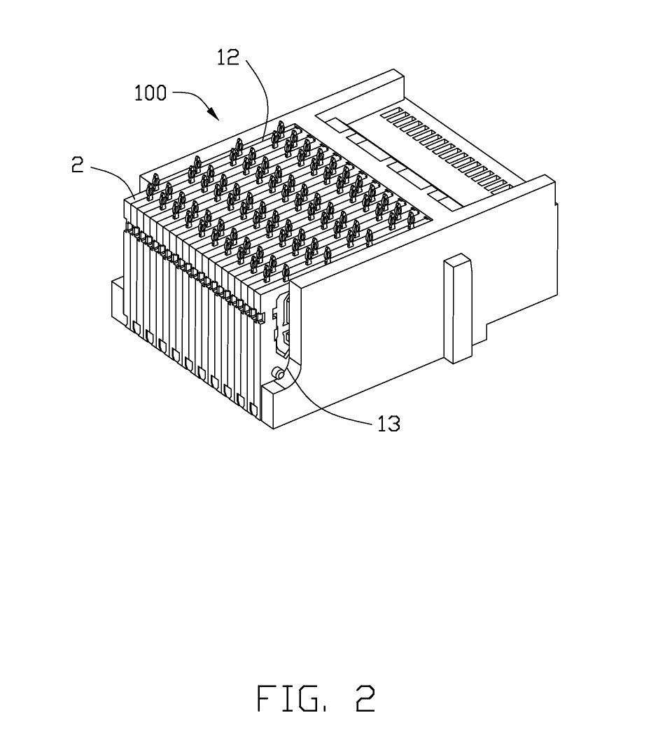

FIGS. 1-2 show an electrical connector 100 according to the invention. The electrical connector 100 includes an insulative housing 1 and a plurality of contact modules 2. The insulative housing 1 defines a mating port 11, a mounting port 13 and a receiving cavity 12. The contact modules 2 forwardly insert into the mating port 11 from the rear mounting port 13. The contact modules 2 are received in the cavity 12. The contact module 2 includes an insulative body 30 and a number of conducative contacts 20 inserte molding with the insulative body 30.

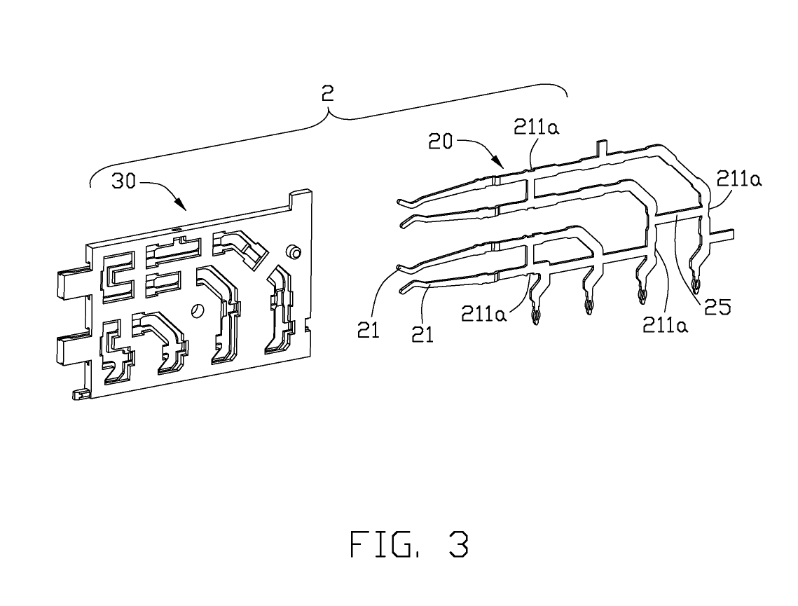

FIG. 3 shows an exploded view of the contact module 2, a number of carring portions have been cut from the contact material band, while the connecting portions 25 between two adjacent contacts 20 are still in the contact material band. There are some compensation portions 211a in the contacts 20. The compensation portions 211a are notches. The insulative body 30 defines a through opening in aligned with the corresponding joint to allow a tool to separating the corresponding end of the connecting portion 25 from the corresponding contact 20.

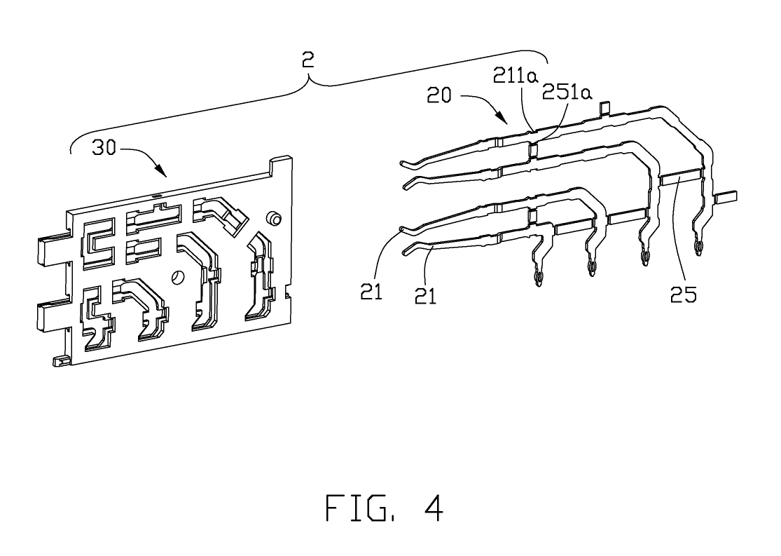

FIG. 4 shows an exploded view of the contact module 2, the connecting portions 25 have been cut from the conductive contacts 20. As the limit of the cutter's precision, each contact has some tubers 251a formed from the cutting portions. The tubers 251a lead the impedance of the conductive contacts 20 discontinuity. The size of the tuber 251a is 0.05-0.10 mm. When stamping the conductive contacts 20, firstly stamp a compensating portion 211a correspending to the tuber 251a. If previous judement is that the contact 20 will form a tuber 251b after cutting the connecting portion 25, the compensating portion 211a will be stamped a notch correspending to the tuber 251a.

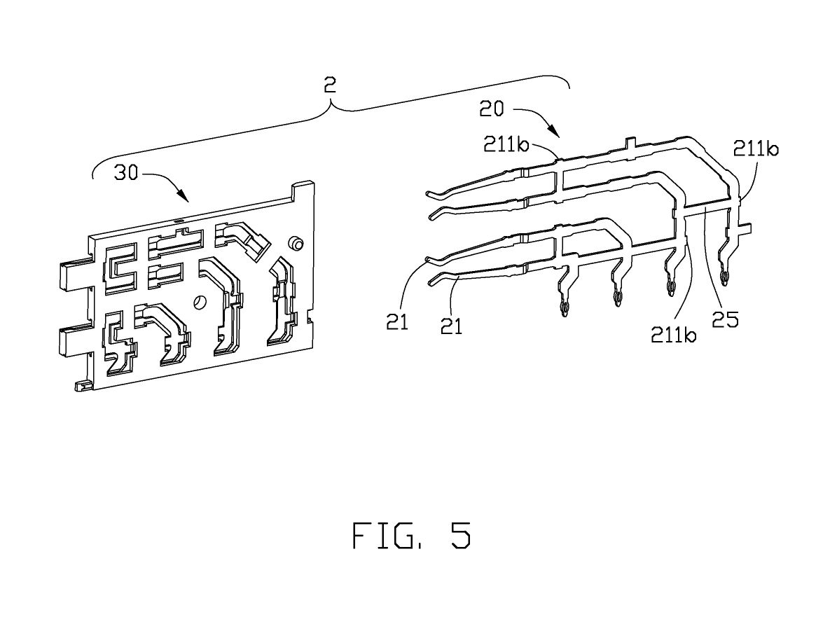

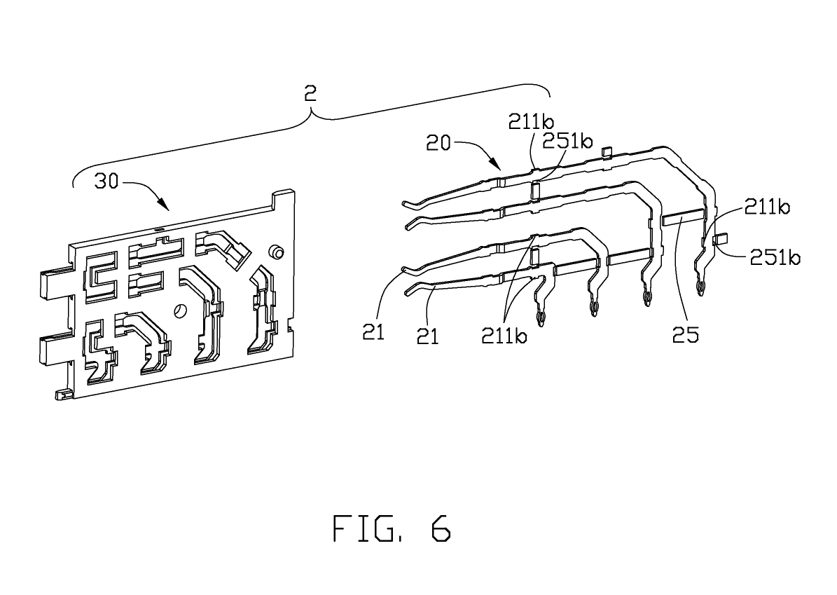

FIGS. 5-6 show another example, a number of carring portions have been cut from the contact material band, while the connecting portions 25 between two adjacent contacts 20 are still in the contact material band. There are some compensation portions 211b in the contacts 20. The compensation portions 211 a are tubers.

A number of connecting portions 25 have been cut from the conductive contacts 20. As the limit of the cutter's precision, each contact has notches 251b formed from the cutting portions. The notches 251b lead the impedance of the conductive contacts 20 discontinuity. The size of the notch 251b is 0.05-0.10 mm. When stamping the conductive contacts 20, firstly stamp a compensating portion 211b correspending to the notch 251b. If previous judement is that the contact 20 will form a notch 251b after cutting the connecting portion 25, the compensating portion 211b will be stamped a tuber correspending to the notch 251b. The compensation portion is formed before said insert molding process.

The contact modules 2 can be manufactured by the following steps:
1) providing a contact strip integrally forming at least a pair of contacts 20 each extending along a first direction while both being spaced from each other in a second direction perpendicular to said first direction with a connecting portion 25 linked therebetween;
2) overmolding an insulative body 30 on said contact strip via an insert molding process with through openings in alignment with joints between the connecting portion 25 and the corresponding contacts 20, respectively, so as to expose said joints in a third direction perpendicular to both said first direction and said second direction;
3) after the insert molding process, via the corresponding through openings, severing the connecting portion 25 from the corresponding contacts 20 at said joints, respectively;
4) wherein for impedance match consideration of the contact 20, when a tuber 251a is formed at the joint, a notch 211a as a compensation portion is formed on the corresponding contact 20 in alignment with the tuber 251a in said second direction; when a notch 251b is formed at the joint, a tuber 211b as the compensation portion is formed on the corresponding contact 20 in alignment with the notch.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A contact module comprising:
a plurality of conductive contacts separating from each other, the contacts formed from a contact material band by cutting a connecting portion connected between two adjacent contacts;
wherein each contact has a tuber or a notch formed by cutting the connecting portion;
wherein each contact has a compensating portion corresponding to the tuber or the notch for impedance matching.

2. The contact module as claimed in claim 1, wherein said compensating portion is a notch correspending to the tuber formd by cutting the connecting portion.

3. The contact module as claimed in claim 1, wherein said compensating portion is a tuber correspending to the notch formd by cutting the connecting portion.

4. The contact module as claimed in claim 1, wherein said compensating portion and the tuber or the notch are disposed at two opposite edges of each contact.

5. A contact module comprising:
an planar insulator enclosing, via an insertion molding process, at lesat a pair of contacts spaced from each other in a first direction and extending in essentially a parallel relation so as to define opposite inner side and outer side on each of the contacts, each of said pair of contacts essentially extending along a second direction perpendicular to said first direction;
said pair of contacts being initially connected with each othere via therebetween a connecting potion linked at the inner sides of the corresponding contacts, respectively, wherein two opposite ends of the connecting portion are successively severed from the corresponding contacts, respectively, with either a tuber or a notch at a joint with the inner side of the corresponding contact; and
a compension portion formed on the outer side of each of the pair of contacts and in aligned with the corresponding joint in said first direction so as to perform impedance matching of the respective contact.

6. The contact module as claimed in claim 5, wherein said connecting portion extends in the first direction.

7. The contact module as claimed in claim 5, wherein the compensation is a notch when the tuber is formed at the joint while is a tuber when the notch is formed at the joint.

8. The contact module as claimed in claim 5, wherein the insulator defines a through opening in aligned with the corresponding joint in a third direction to allow a tool to separating the corresponding end of the connecting portion from the inner side of the corresponding contact.

9. A method of making a contact module, comprising steps of:
providing a contact strip integrally forming at least a pair of contacts each extending along a first direction while both being spaced from each other in a second direction perpendicular to said first direction with a connecting portion linked therebetween;
overmolding an insulator on said contact strip via an insert molding process with through openings in alignment with joints between the connecting portion and the corresponding contacts, respectively, so as to expose said joints in a third direction perpendicular to both said first direction and said second direction;
after the insert molding process, via the corresponding through openings, severing the connecting portion from the corresponding contacts at said joints, respectively, wherein
for impedance match consideration of the contact, when a tuber is formed at the joint, a notch as a compensation portion is formed on the corresponding contact in alignment with the tuber in said second direction; when a notch is formed at the joint, a tuber as the compensation portion is formed on the corresponding contact in alignment with the notch.

10. The method as claimed in claim 9, wherein said connecting portion extends in the second direction.

11. The method as claimed in claim 9, wherein the compensation portion is formed before said insert molding process.
